(19) United States
(12) Patent Application Publication
(10) Pub. No.: US 2013/0279893 A1
(43) Pub. Date: Oct. 24, 2013

(54) DEVICES FOR POSITIONING SUBJECTS

(71) Applicant: ACCESS BUSINESS GROUP INTERNATIONAL LLC, Ada, MI (US)

(72) Inventors: Richard C. Roth, Ada, MI (US); Matthew DePauw, Greenville, MI (US); Andrew Hepner, Grand Rapids, MI (US)

(73) Assignee: Access Business Group International LLC, Ada, MI (US)

(21) Appl. No.: 13/827,932

(22) Filed: Mar. 14, 2013

Related U.S. Application Data
(60) Provisional application No. 61/635,592, filed on Apr. 19, 2012.

(51) Int. Cl. G03B 15/00

(52) U.S. Cl. CPC G03B 15/00
USPC 396/5

(57) ABSTRACT

Devices and methods for reproducibly positioning a subject are described. A device may include a first parallax bar assembly having a first wire and a second wire spaced a first distance and parallel to the first wire, and a second parallax bar assembly having a third wire and a fourth wire spaced a second distance and parallel to the third wire. The first and second wires are substantially perpendicular to the third and fourth wires, and an imaginary straight line intersects the first, second, third, and fourth wires. Some devices may include a chair and a headrest for positioning a subject.

### RELATED APPLICATIONS

This application claims priority under 35 U.S.C. §119(e) to U.S. Provisional Application No. 61/635,592, “DEVICES FOR POSITIONING SUBJECTS” filed Apr. 19, 2012, the entire contents of which are incorporated by reference.

### FIELD

The present disclosure is directed generally to reproducibly positioning subjects and more particularly to positioning and re-positioning a head of a subject.

### BACKGROUND

Subject immobilizing devices provide a way of maintaining a subject in a particular position while images are taken of them. Such immobilizing devices include head rests, ear plug holders, helmets, chin rests, and forehead rests.

Many of these devices restrain the face, neck, chin or forehead, which modify the face and skin and deform the subject. As a result, images of such a restrained subject are not ideal. Forehead rests cause pressure points, chin rests deform the lower half of the face, and combinations of forehead and chin rests do not address tilt and rotation of the head. Many rigid head holders also prevent or encumber side oriented or profile images and typically strain the neck.

Furthermore, many devices result in variations in alignment of the subject in each dimension of several millimeters up to centimeters. The direction of the head, changes in twist, tilt, rotation, and yaw will be variable and can change during image acquisition and can vary considerably between imaging sessions. Consequently, certain “no restraint” systems are inadequate at providing accurate reproducible positioning of the subject at a later time.

### SUMMARY

Described herein are devices and methods of positioning a subject. In one embodiment, a device for positioning a subject includes a first parallax bar assembly having a first wire and a second wire spaced a first distance and parallel to the first wire. The device further includes a second parallax bar assembly having a third wire and a fourth wire spaced a second distance from and parallel to the third wire. The first and second wires are substantially perpendicular to the third and fourth wires, and an imaginary straight line intersects the first, second, third, and fourth wires.

The first parallax bar assembly may further include a first support parallax bar having a first portion and a second portion, and the first and second wires extend from the first portion to the second portion of the first support parallax bar. Similarly, the second parallax bar assembly may further include a second support parallax bar having a first portion and a second portion, the first and second wires extend from the first portion to the second portion of the second support parallax bar.

The first distance may be between about 2 and about 12 inches, and the second distance may be between about 0.5 and about 12 inches. Furthermore, the first and second wires and/or third and fourth wires may be vertically adjustable. For example, the device may include an adjustable support stand coupled to the first and/or second parallax bar assembly to allow vertical adjustment of the first and/or second parallax bar assembly. The first and second wires and/or third and fourth wires may be horizontally adjustable toward and away from a subject. For example, the device may include an adjustable support bracket coupled to the first and/or second parallax bar assembly to allow horizontal adjustment of the first and/or second parallax bar assembly. The first wire and the second wire may be configured to be generally tangential to a ground plane in use, and the third wire and the fourth wire may be configured to be generally perpendicular to the ground plane in use.

The device may further include a back target having a back target color that is different from a color of at least one of the first, second, third, and fourth wires, and the back target positioned along the imaginary straight line. Furthermore, the first wire may have a first color and the second wire may have a second color different from the first color. The first wire may have a first thickness and the second wire may have a second thickness greater than the first thickness.

The device may further include an alignment chair with a headrest configured to restrict movement of a subject's head without touching a subjects face, neck, chin or forehead. For example, the headrest may include at least two occipital touch points configured to touch an occipital portion of a subject's head where a first occipital touch point is generally on a right side of the subject's head and a second occipital touch point is generally on a left side of the subject's head, and at least one frontal touch point configured to touch a frontal portion of the subject's head.

In one embodiment, a method of aligning a device with respect to a subject includes positioning, to a first position, a first parallax bar assembly comprising a first wire and a second wire spaced a first distance from and substantially parallel to the first wire such that a line of sight of the subject intersects the first and second wires. For example, the method may include at least partially occluding the second wire from the subject.

The method may further include positioning, to a second position, a second parallax bar assembly comprising a third wire and a fourth wire spaced a second distance from and parallel to the third wire such that the line of sight of the subject generally intersects the third and fourth wires. For example, the second parallax bar assembly may be positioned such that the fourth wire is equal distance from each of subject's observed images of the third wire. The positioning of the second parallax bar assembly may further include positioning a common plane that the third and fourth wires lie substantially equal distance between eyes of the subject.

The method may include moving the first parallax bar assembly from the first position and moving the second parallax bar assembly from the second position, and repositioning the first parallax bar assembly to the first position after moving the first parallax bar assembly and repositioning the second parallax bar assembly to the second position after moving the second parallax bar assembly.

In further embodiments, a chair-headrest device for positioning a subject is provided. The device includes a chair and a headrest system adjustable relative to the chair. The headrest system may have an occipital head set point with at least one occipital touch point configured to touch an occipital portion of a head of a subject and a frontal head set point with at least one frontal head touch point configured to touch a frontal portion of the head of the subject. The occipital head set point and frontal head set point may be adjustable in at least two dimensions.

The occipital head set point may include at least two occipital touch points separated by a distance and configured to touch the occipital portion of the head. The two occipital touch points may be configured with at least one occipital touch point on each side of a sagittal plane of the subject.

### BRIEF DESCRIPTION OF THE DRAWINGS

FIG. 1 is a perspective view of an embodiment of a device with parallax bar assemblies for positioning a subject as described herein;

FIG. 2 is a perspective view of another embodiment of a device with parallax bar assemblies for positioning a subject as described herein;

FIG. 3 is a front perspective view of a device that includes parallax bar assemblies and cameras for taking images of a subject;

FIG. 4 is a side perspective view of a system that includes the device with parallax bar assemblies of FIG. 3 for positioning a subject and a chair-headrest device for supporting the subject as described herein;

FIG. 5 is a side view of the chair-headrest device of FIG. 4 that includes a chair and headrest as described herein; and

FIG. 6 is a close-up view of an adjustable support stand of the chair-headrest device of FIG. 5.

### DETAILED DESCRIPTION

Described here are devices and methods for positioning at least a portion of a subject such as the head, face, and/or neck of the subject. For example, the device may be utilized to align and position a subject to a defined reproducible focal point. In certain circumstances, the positioning may be for a limited period; therefore, the devices and methods can assure reproducible positioning of the subject. Furthermore, this device may be a stand-alone component for subject alignment and positioning or may be combined with other components to further facilitate subject alignment and positioning.

Devices may include a height adjustable set of paired parallel horizontal and vertical fixed “wires” (e.g., parallax wires) through which a subject views and maintains a stationary position. The two sets of parallax wires oriented (e.g., 90 degrees) directionally to one another and mounted to a support which may in turn be adjusted for height. The two sets of parallax wires allow reproducible positioning of the subject.

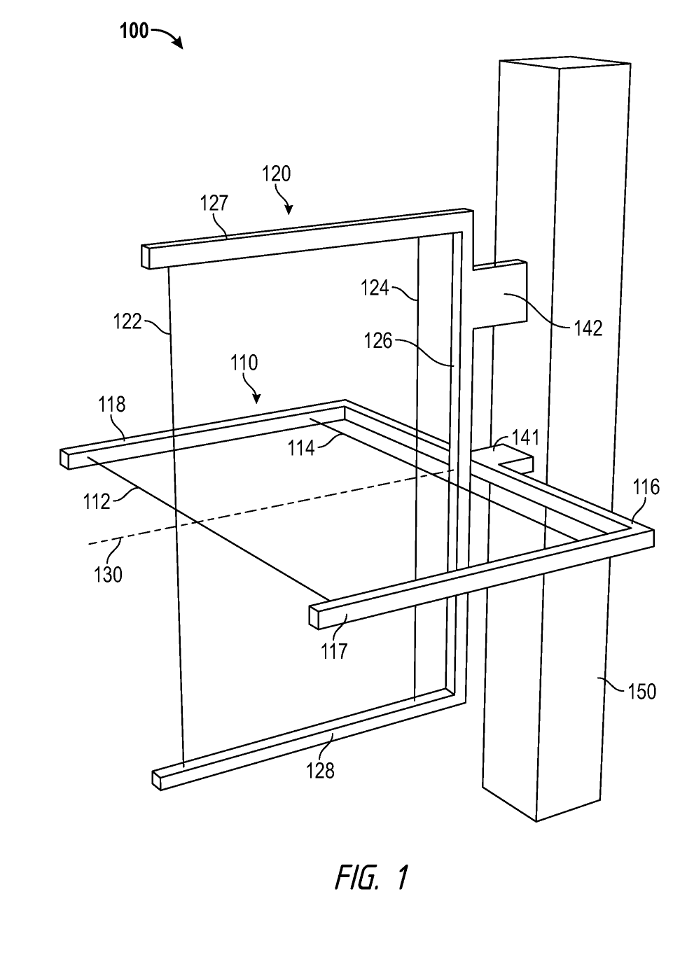

FIG. 1 is a perspective view of an embodiment of a device (e.g., parallax device) 100 for positioning a subject. The device 100 includes a first parallax bar assembly 110 that has a first wire 112 (e.g., first horizontal wire) and a second wire 114 (e.g., second horizontal wire) spaced a first distance from and substantially parallel to the first wire 112.

The terms “wire” and “parallax wire” used herein includes any shape that is able to be used for viewing and representing a particular plane. For example, a wire may be a long thin material that is held in a straight or stretched mounting. As such, the term “wire” may include polymeric line, tape, flat wire, rods, bars, poles, etc.

The first parallax wire 112 is closer to the subject and the second parallax wire 114 is farther from the subject. The first and second parallax wires 112, 114 can be mounted and held tight in a manner that permits both the first and second parallax wires 112, 114 to be in a first plane (e.g., both the first and second parallax wires 112, 114 are in the same or common geometric plane). The first and second parallax wires 112, 114 may be mounted several centimeters apart such as between about 5 to about 30 cm, between about 15 and about 25 cm, between about 15 to about 20 cm, or about 20 cm. The first and second parallax wires 112, 114 are spaced to permit viewing overlap across the length of the first and second parallax wires 112, 114 within a defined viewing zone. The exposed length of each of the first and second parallax wires 112, 114 may be between about 10 to about 75 cm in length or between about 40 and about 50 cm in length. The viewing zone for alignment may be centered substantially at a middle zone of the first and second parallax wires 112, 114. The viewing zone along the first and second parallax wires 112, 114 may be between about 10 and about 20 cm in length, and between about 12 and about 17 cm in length.

The first and second parallax wires 112, 114 are intended to provide a means of “parallax overlay” during viewing with both eyes. When the viewing axis of the subject is aligned with both first and second parallax wires 112, 114, the first wire 112 (e.g., the wire closer to the subject) may partially or fully occlude the second wire 114 (e.g., the wire farther from the subject) depending on relative thicknesses of the first and second parallax wires 112, 114.

The wires may be of various dimensions, shapes, and materials. For example, the wires may be polymer wires. The wires may be sufficiently thin to permit easy viewing from a distance of up to about 1 to about 2 meters. However, the wires can also be sufficiently thick to prevent involuntary vibration. The first and second wires 112, 114 may be thinner rather than thicker. Thinner wire permits more specific alignment. For example, the first wire 112 may have a thickness of about 0.44 to about 1.33 mm, and second wire 114 may have a thickness of about 0.44 to about 1.5 mm. The wire closer to the subject may be of any color. For example, the wire closer to the subject may be a light color (e.g., white). The wire farther from the subject may also be of any color. For example, the wire farther from the subject may be a darker color (e.g., black) and a color that is not the same as the closer wire. The wire farther from the subject (e.g., the second wire 114) may be slightly thicker than the closer wire to the subject (e.g., the first wire 112) to ease more precise overlay alignment. Alternatively or additionally, the wires may be colored. For example, wires formed from polymers may contain coloring or dyes added during processing so that the wire exhibits a visible color. Alternatively, the wire may be coated with a coloring.

The first parallax bar assembly 110 may also include a first support parallax bar 116 having a first portion 117 and a second portion 118. The first and second wires 112, 114 extend from the first portion 117 to the second portion 118 of the first support parallax bar 116. The first parallax bar assembly 110 supports and maintains the position of the first and second wires 112, 114. The first and second wires 112, 114 may be fixed and parallel within the first parallax bar assembly 110, but the first parallax bar assembly 110 may be able to be adjusted forward or backward to accommodate optimized set-up distances from a subject's position.

The device 100 also includes a second parallax bar assembly 120 that has a third wire 122 (e.g., first vertical wire) and a fourth wire 124 (e.g., second vertical wire) spaced a second distance from and substantially parallel to the third wire 122. The third wire 122 is closer to the subject and the fourth parallax wire 124 is farther from the subject. The third and fourth parallax wires 122, 124 can be mounted and held tight in a manner that permits both the third and fourth parallax wires 122,124 to be in a second plane (e.g., the third and fourth parallax wires 122,124 are in the same or common geometric plane).

The third and fourth parallax wires 122, 124 may be mounted several centimeters apart such as between about 5 to about 30 cm, between about 15 to about 25 cm, between about 15 to about 20 cm, or about 20 cm. The third and fourth parallax wires 122, 124 are spaced to permit viewing overlap across the length of the third and fourth parallax wires 122, 124 within a defined viewing zone. The exposed length of each of the third and fourth parallax wires 122, 124 may be between about 10 to about 75 cm in length or between about 40 and about 50 cm in length. The exposed length of each of the third and fourth parallax wires 122, 124 may be less than the exposed length of each of the first and second parallax wires 112, 114. Alternatively, the exposed length of each of the third and fourth parallax wires 122, 124 may be greater than the exposed length of each of the first and second parallax wires 112, 114. The viewing zone for alignment may be centered substantially at a middle zone of the third and fourth parallax wires 122, 124. The viewing zone along the third and fourth parallax wires 122, 124 may be between about 10 and about 20 cm in length or between about 12 and about 17 cm in length.

The wire closer to the subject (e.g., the third parallax wire 122) is intended to be viewed double (e.g., once by each eye) and serve as an “equidistant parallax frame” around the wire farther from the subject (e.g., the fourth parallax wire 124).

The third and fourth parallax wires 122, 124 may have a similar or different shape, size, and material as the shape, size, and material of the first and second parallax wires 112, 114. The third and fourth parallax wires 122, 124 may be thicker rather than thinner. Thicker wire permits a more specific alignment. For example, the third and fourth wires 122, 124 may have a thickness of about 0.44 to about 2.5 mm. The wires may be of any color. The wire closer to the subject (e.g., the third parallax wire 122) may be dark, and the wire farther from the subject (e.g., the fourth parallax wire 124) may be of a different dark color than the closer wire to aid in distinguishing the wires from each other and for recognizing an equal separation on either side of the wire. For example, the third parallax wire 122 may comprise a dark color (e.g., black) that does not substantially reflect light, and the fourth parallax wire 124 may comprise a dark color that does not substantially reflect light and a light color that does substantially reflect light (e.g., white) such as the dark color is striped with the light color.

The second parallax bar assembly 120 may further include a second support parallax bar 126 having a first portion 127 and a second portion 128. The third wire 122 and the fourth wire 124 extend from the first portion 127 to the second portion 128 of the second support parallax bar 126. The second parallax bar assembly 120 supports and maintains the position of the third and fourth wires 122, 124. The third and fourth wires 122, 124 may be fixed and parallel within the second parallax bar assembly 120, but the second parallax bar assembly 120 may be able to be adjusted forward or backward to accommodate optimized set-up distances from the subject's position.

The first and second parallax wires 112, 114 and third and fourth parallax wires 122, 124 are mounted with respect to each other at a defined angle such as about 90 degrees. For example, the third and fourth wires 112, 114 can be substantially perpendicular to the third and fourth wires 122, 124, and an imaginary straight line 130 intersects the first, second, third, and fourth wires 112, 114, 122, 124. Furthermore, when the subject is aligned with the device 100, the subject's line of sight is also substantially along this imaginary straight line 130.

The first and second parallax wires 112, 114 and the third and fourth parallax wires 122, 124 can be in relatively close proximity to each other. For example, the first wire 112 and the third wire 122 may be spaced between each other about 1 to about 30 cm along the imaginary straight line 130. Similarly, the second wire 114 and the fourth wire 124 may be spaced between each other about 1 to about 30 cm along the imaginary straight line 130.

Each parallax wire can be held straight, firm, and parallel to the other wire in the same parallax bar assembly. The wires may be held in place through means of tension or alignment. The arrangement of the wire in the parallax bar assembly can be repeatable and replaceable. Consequently, use of rigid wire (similar to a rod), while acceptable, may not be preferred due to the potential for bending. Lengths of wire with a tensioner may be used as a means of securing the wire to the support parallax bar. The parallax wires are held in the support parallax bars either in a stationary permanent location or may be movable while being maintained parallel. Under certain circumstances for testing, the wires in the device are intended to be held fixed for the duration of a study.

As described above, the first and second parallax wires 112, 114 and the third and fourth wires 122, 124 may be maintained in a 90 degree orientation to each other. The first and second wires 112, 114 can be maintained at a flat angle or parallel to the working surface (e.g., floor) as defined by the connection to a support structure such as a first adjustable support bracket 141 and an adjustable support stand 150. The third and fourth wires 122, 124 can be maintained at a 90 degree angle or perpendicular to the working surface as defined by the connection to the support structure such as a second adjustable support bracket 142 and the adjustable support stand 150. The horizontal orientation of the first and second wires 112, 114 and vertical orientation of the third and fourth wires 122, 124 are intended to maintain the subject's head in a normal and upright position. Other arrangements of the parallax wires may be used to maintain a different direction of gaze if necessary for a study.

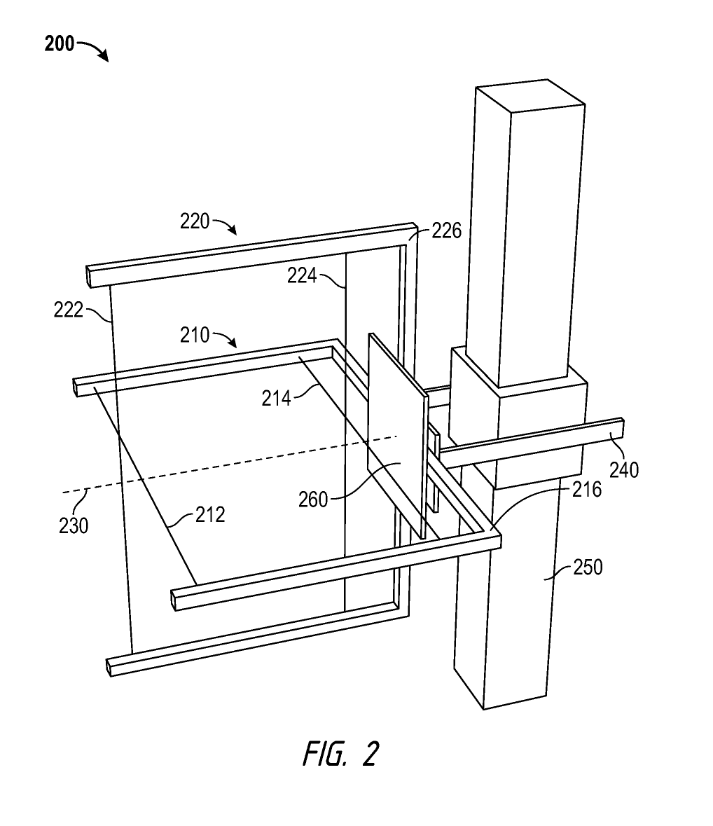

FIG. 2 is an example of a device 200 for positioning a subject that also includes a back target 260. The back target 260 serves as a standard contrast background for the parallax wires 212, 214, 222, 224 for easy viewing such that all the parallax wires 212, 214, 222, 224 may be compared and viewed using the back target 260 as the base background surface. The back target 260 may be of any color or composition. For example, the back target 260 may be non-glossy (e.g., dull) and be a light color such that the light color is a contrasting color to the darker parallax wires 212, 214, 222, 224 such as white. The back target 260 can also be substantially uniform in color. Furthermore, the back target 260 may be parallel to the parallax wires 212, 214, 222, 224 and may be a flat viewing platform. All the parallax wires 212, 214, 222, 224 are between the subject and the back target 260 such that the imaginary line 230 intersects the back target 260, and the back target 260 may be substantially centered at the parallax wire intersection point when viewed as intended. The back target 260 may have a width, height, or diameter of about 15 to about 75 centimeters. The back target 260 may be directly mounted to the support bracket 240. Also, the back target 260 can be maintained uniform and clean.

A device 200 may also include a support bracket 240, as mentioned above. The support bracket 240 holds the parallax bar assemblies 210, 220 in place and mounts the parallax bar assemblies 210, 220 to an adjustable support stand 250. The support bracket 240 may be fixed or adjustable. Adjustable movement of the support bracket 240 forward or backward in slots maintains perpendicular and parallel relationships of the components. The support bracket 240 may include one or more fasteners to maintain the support bracket 240 in position once defined. The support bracket 240 can both support and maintain a position of the parallax bar assemblies 210, 220.

The support bracket 240 may be constructed of firm material such as aluminum. The support bracket 240 may be 90 degrees to the support parallax bars 216, 226 and the adjustable support stand 250. Support brackets may be mounted independently and adjusted separately, or integral to each other. For example, a single support bracket 240 may be coupled to both the first parallax bar assembly 210 and the second parallax bar assembly 220, or as illustrated in FIG. 1, the first parallax bar assembly 110 can be coupled to a first support bracket 141 and the second parallax bar assembly 120 can be coupled to a second support bracket 142. The support brackets 141, 142, 240 may be movable independently or integrally. If mounted integrally, the parallax bar assemblies 110, 120, 210, 220 may be rendered as either a fixed box or bar support system.

The support stand 150, 250 provides a means of adjusting and maintaining position of the parallax bar assemblies 110, 120, 210, 220. The support stand 150, 250 can be an adjustable stand that permits an increase or decrease in elevation of the support bracket(s) 141, 142, 240 with the parallax bar assemblies 110, 120, 210, 220. The support stand 150, 250 can include a reticulated rule to permit definition and reorientation in height to a predetermined value. The support stand 150, 250 may be constructed from a camera enlarger or copy stand oriented in an upright position. The support stand 150, 250 may also be mounted to a rigid tripod or other permanent support and fixed in location and alignment (e.g., floor placement) throughout a study.

The support stand 150, 250 can also be in other configurations that prevent vibration of the parallax bar assemblies 110, 120, 210, 220 during use as well as being sturdy enough to not warp with movements of the parallax bar assemblies 110, 120, 210, 220 and the support brackets 141, 142, 240. Other configurations include the first parallax bar assembly 110, 210 and the second parallax bar assembly 120, 220 being independently adjustable from one another in one or more directions (e.g., horizontal, vertical, forward and back, or height).

A reticulation (e.g., rule) can be included with the support stand 150, 250 for purpose of defined reorientation. The upper and lower limits of reticulated rule should be sufficient to encompass the vast majority of subjects and have a dynamic range for either sitting or standing height, depending on the study. The reticulated rule on the support stand 150, 250 may cover the vertical distance above the floor from about 50 cm to about 240 cm or may cover a range from about 100 cm to about 215 cm for most subjects. The reticulated rule can allow the resetting of the position of the parallax bar assemblies 110, 120, 210, 220 within about 0.1 to about 0.2 mm of a previously measured position.

Such devices 100, 200 can align a subject for tilt, rotation, and yaw. Once the alignment is obtained, the reticulated rule values from each of the parameters are recorded such as height of the support stand 150, 250 as well as position of any other components of the device 100, 200. The resetting of the parameters permits the subject to return to the same condition for further measurements at a later date. Each of the parameters can be realigned to within at least about 0.1 to about 0.2 mm. Subjects have been found to move minimally as compared to no alignment even when the subject is free standing when aligned dynamically using just the parallax bar assemblies 110, 120, 210, 220 whether or not additional subject stabilization means are used. Consequently, the device 100, 200 is an alignment tool that can be used independently for photographic alignments and repositioning.

The orientation in space of the parallax bar assemblies 110, 120, 210, 220 when viewed does not have to be precisely horizontal/vertical or level. However, the position of the parallax bar assemblies 110, 120, 210, 220 can be able to be repositioned into a previous position to be able to realign a subject. For example, for the entire study of a subject, the device 100, 200 may not be moved or disassembled to provide consistent alignment of the subject.

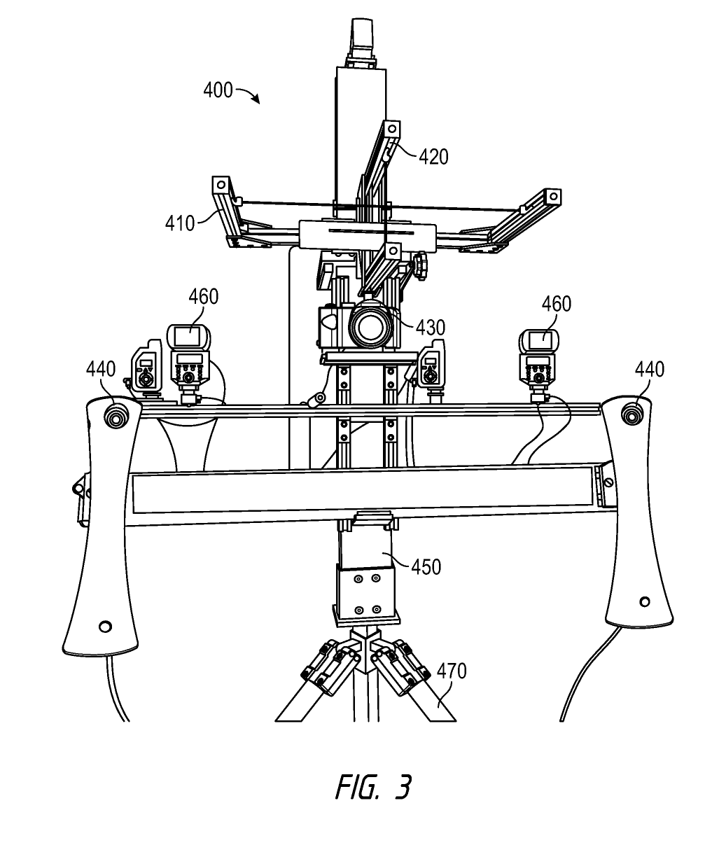

After the subject has been aligned, photographs or images of the subject can be taken. FIG. 3 illustrates a device 400 similar to the devices 100, 200 described in FIGS. 1 and 2. Thus, the features of the devices 100, 200 of FIGS. 1 and 2 can be applied to the device 400 of FIG. 3. In addition, the features of the device 400 of FIG. 3 described below can be applied to the devices 100, 200 of FIGS. 1 and 2. The device 400 can include a parallax bar assemblies 410, 420. The device 400 can include a 2D camera system 430 and/or a 3D camera system 440 for acquiring photographs of an aligned subject. The camera systems 430, 440 can be mounted to a support stand 450. The camera systems 430, 440 may be positioned in relatively close proximity of the parallax bar assemblies 410, 420, as illustrated in FIG. 3, or the camera systems 430, 440 can be positioned further away. However, the relative position of the parallax bar assemblies 410, 420 to the position of the camera systems 430, 440 can be maintained throughout the study to be able to compare images. The device 400 can also include one or more lights 460 such as flashes to provide sufficient light to take images. The lights 460 can also be mounted to the support stand 450. The device 400 may further include a computer system that includes a processor for acquiring digital images.

As described above, the device 400 can also include various support structures to adjustably position the parallax bar assemblies 410, 420 relative to a subject. For example, as illustrated in FIG. 3, the device 400 can include a tripod 470 to support the parallax bar assemblies 410, 420, camera systems 430, 440, and/or lights 450.

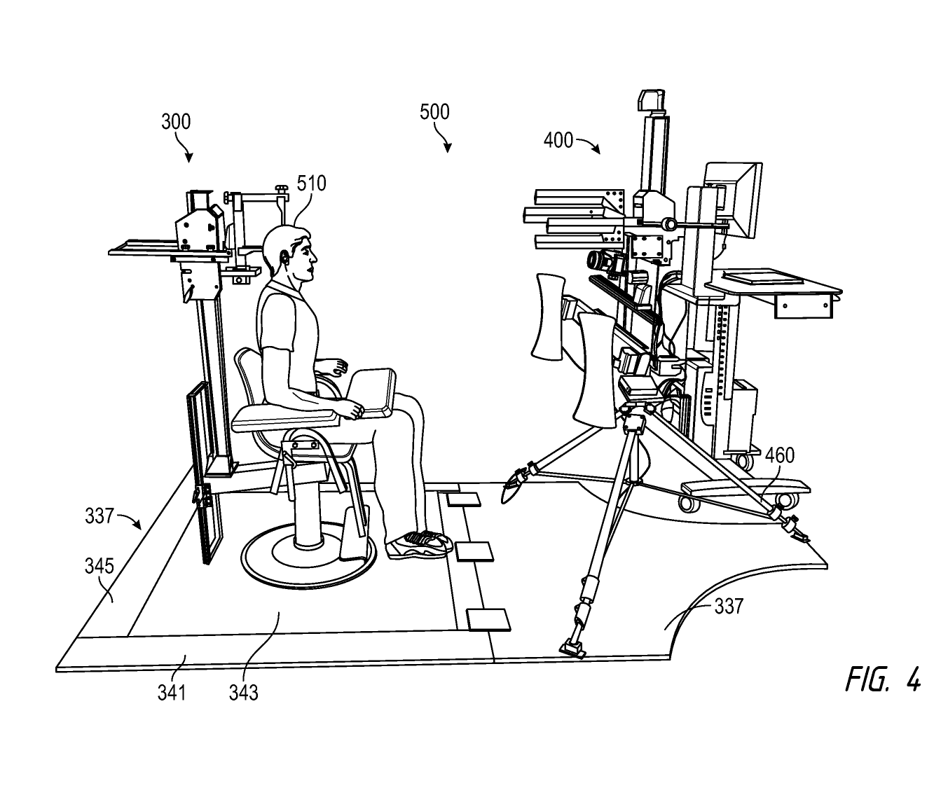

A system for positioning a subject may include additional components for positioning a subject beyond those devices described above such as a device able to support the subject. FIG. 4 is a perspective view of a system 500 for positioning a subject 510 that includes the parallax device 400 of FIG. 3. The system 500 also can include a second device 300 for adjustably positioning the subject. The second device 300 can be a combined chair and headrest for subject alignment and for positioning the subject in a defined subject specific position. A subject can be seated in a chair with back of head and top of head touch points. The subject, once aligned in the chair and aligned to the parallax wires, does not move for a short period of time, maintaining the touch points, during the image acquisition. The parallax wires permit the subject to maintain head alignment. Realignment using the parallax wires and the chair with headrest assures co-location of the subject for repositioning at later times. The subject can be repositioned to within about 0.1 to about 0.2 mm tolerance of the prior position without being encumbered by devices that would otherwise modify the head, face and neck for dimensional measurement and imaging. The results of such measurements indicate the subjects maintain full facial realignment within a measured value of about 1 mm or less in three dimensions. This excellent realignment permits accurate measurement of the change in head, face, and neck dimensions and volume. Additional ultrafine realignment may also be conducted through computer adjustment of images such as those provided through GFMesstechnik PRIMOS 3D systems.

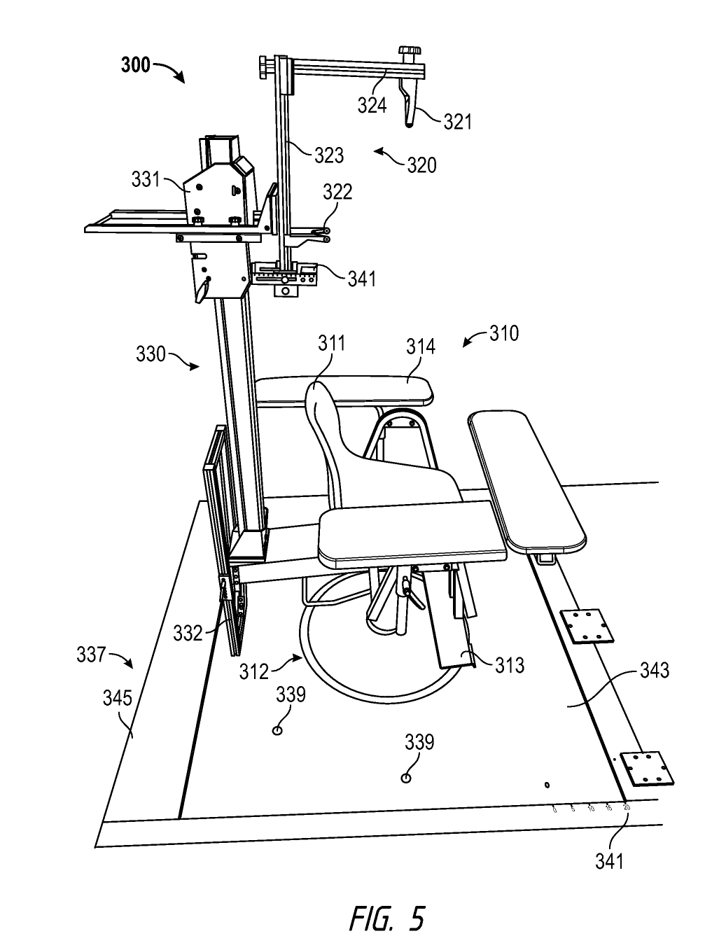

FIG. 5 is a side view of the device (e.g., chair-headrest device) 300 of FIG. 4 for positioning a subject that includes a chair 310 and a headrest 320. The chair-headrest device 300 can be used with or without the parallax devices 100, 200 described above. The chair 310 may be adjustable for height and/or rotation or may be maintained in a single set position per study. For example, the chair 310 can have a frame 312 that can adjust height of the chair-headrest device 300. A headrest 320 may be attached to the frame 312. The headrest 320 may include two or more head set points such as a frontal (e.g., top or superior of the head) head set point 321 and an occipital (e.g., back or posterior of the head) head set point 322. The height of the headrest 320 may be adjustable, and the head set points 321, 322 may also be adjustable. The combination of the position of the chair 310, height of headrest 320, and position of the top of head set point 321 maintains a subject in a reproducible subject specific position. Additional fine positioning of the subject, within the chair-headrest device 300, for facial/head orientation can be accomplished using parallax devices 100, 200, 400 described above. For example, a system for positioning a subject may include the chair-headrest device 300 and the parallax device 100, 200, 400.

The chair 310 can include height and/or rotational adjustment. Furthermore, the chair 310 can include one or more locking mechanisms to lock the chair 310 into a particular position. For example, when the chair 310 is locked, the chair may have substantially no vertical or rotational movement. The positioning of the chair 310 can be relative to or with respect to a focal point such as parallax bar assemblies and/or the floor or ground. Furthermore, the seat portion and/or backing portion of the chair 310 may be formed of a rigid material. In some instances, the seat and/or backing portion are devoid of padding since padding may compress differentially and cause a change of position of the subject.

The chair 310 may be sufficiently strong so as to not warp with weight. For example, the chair 310 may be a heavy frame phlebotomy chair. The chair 310 may further include a foot rest 313 integrated or detachable to the seat or frame of the chair 310. The chair 310 may also include arms 314. The arms 314 may be rigid and not include padding. As previously discussed, padding can compress differentially and cause a change of position of the subject.

An adjustable support stand 330 mechanically connects the chair 310 with the headrest 320. The adjustable support stand 330 allows for adjustable and repositionable height of the headrest 320 relative to the chair 310. For example, the adjustable support stand 330 may be a vertically adjustable reticulated mount such as an imaging enlarger stand or equivalent. The chair 310 may include a removable pedestal bracket for mounting the adjustable support stand 330. The adjustable support stand 330 may be sturdy enough to maintain a position in use, to not vibrate during normal use, and to not warp with movement of the headrest 320. The adjustable support stand 330 may include reticulation marks (rule) to be able to define reorientation. For example, the reticulation marks may permit an interpolation of at least about 0.2 to about 0.1 mm.

The adjustable support stand 330 can include a headrest mount 331 to which the headrest 320 is mounted. The adjustable support stand 330 may hold the entire headrest 320 including the head set points 321, 322. The headrest mount 331 can allow horizontal and vertical adjustment of the headrest 320. For example, the headrest mount 331 can include vertically and horizontally adjustable brackets. The horizontally adjustable bracket can be capable of sufficient movement to accommodate subjects of varying dimensions for weight and head size. The headrest mount 331 can include reticulated rules on each adjustable component. Each rule may be able to be repositioned to within about 0.1 to about 0.2 mm of a parameter setting.

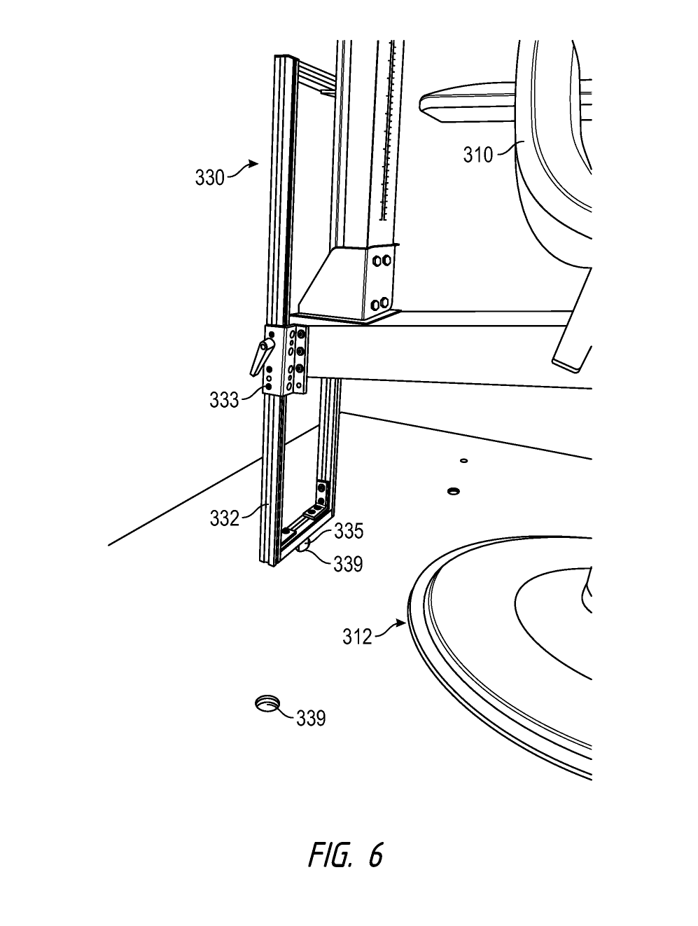

The adjustable support stand 330 may further include a support mechanism 332 such as a “third-leg” to further stabilize the second device 300. FIG. 6 is a close-up view of the support mechanism 332 of FIG. 5. The support mechanism 332 can include a vertical adjustment 333 for raising and lowering the support mechanism 332. The support mechanism 332 can also include an aligning support member 335 such as a peg for aligning the second device 300 relative to a template 337 or a floor. The aligning support member 335 can be configured to engage with an aligning template member 339 such as a hole of the template 337. The template 337 can also include more than one aligning template member 339 so that second device 300 can be rotated about the frame 312 to select angles. For example, the alignment chair 310 can be configured to be rotatable about an axis perpendicular to a plane of template 337 and removably engaged with the template 337 at at least two positions on the template 337. For instance, the template 337 can include a first aligning template member 339 such that when the aligning support member 335 is engaged with the first aligning template member 339, the subject is facing the device 400. The template 337 can include additional aligning template members 339 such that the second device 300 is rotated to specified angles relative to the first aligning template member 339 such as 45 and/or 90 degrees clockwise and/or counterclockwise. The aligning template members 339 can provide multiple repeatable subject alignments. For example, if the first aligning template member 339 results in the subject facing the device 400, a second aligning template member 339 that is 90 degrees from the first aligning template member 339 can result in the subject facing away from the device 400 such that a side of the subject faces the device 400.

Furthermore, the template 337 can be configured so that the second device 300 is movable relative to the parallax device 400. For instance, the template 337 can be configured so that the second device 300 is horizontally movable relative to the parallax device 400. The template 337 can include a base member 341 and a movable member 343 that is horizontally movable relative to the base member 341. The second device 300 can be coupled to the movable member 343. The movable member 343 can be disposed in a slot or groove 345 of the base member 341. The slot 345 can extend in a direction generally toward the parallax device 400 so that the movable member 343 can slid along the slot 345 toward and away from the parallax device 400. The movable member 343 and the base member 341 can include markings such as measurements so that the movable member 343 and the second device 300 can be repositioned relative to the parallax device 400. For example, the markings can be used to position the second device 300 a particular distance from the parallax device 400. The template 337 can also include a locking mechanism to lock the movable member 343 relative to the base member 341. The horizontal movement of the second device 300 can provide focusing for the camera systems 430, 440 and/or repositioning of the subject relative to the parallax device 400. Although the template 337 is shown in FIGS. 4 and 5 to move the second device 300 towards and away from the parallax device 400, the template 337 can be configured to move the second device 300 in other directions relative to the parallax device 400 such as laterally. Moreover, the template 337 can be configured so that the parallax device 400 is movable (e.g., horizontally movable) relative to the second device 300. For example, the template 337 can include a similar configuration as that described with regard to the second device 300 to enable the parallax device 400 to be movable.

Each component may be able to be repositioned using the reticulated rule attached to it to within about 0.1 to about 0.2 mm. Each component may also be able to be easily reset (e.g., not hard connected). Furthermore, the combined set of adjustable parameters (e.g., stand height, stand rotation, head rest depth, headrest height, top of head bracket, top of head touch point) can be easily repositioned per subject.

Referring back to FIG. 5, the headrest 320 can include a headrest support slide 323 that holds the occipital head set point 322 and the frontal support slide 324. The headrest support slide 323 can be adjustable or may be locked in a vertical position. For example, the headrest support slide 323 may be adjusted to accommodate either an extremely short or extremely tall subject. The headrest support slide 323 may have a duo track support with a lock for reticulated rule positioning for both the occipital head set point 322 and the frontal head set point 321. The headrest support slide 323 may further include a vertical reticulation rule. The headrest support slide 323 may not warp and be, for example, an extruded aluminum frame.

The occipital head set point 322 may include at least one or at least two touch points. If the occipital head set point 322 includes two touch points, the touch points may be positioned or spaced from one another a distance of about 20 to about 100 mm. Furthermore, the two touch points may be positioned or spaced on either side of a sagittal plane of the subject. The touch points may have rounded ends to serve as touch points to the back of the head below the center of the head such that the touch points rest near or on the occipital bone of the head. The touch points may be positioned so that the touch points do not contact the parietal bone of the head. The rounded ends can prevent indentation and discomfort to the subject. The touch points may be of any hard washable material such as molded plastic such as nylon and be of sufficient strength so as to not warp with head pressure. The occipital head set point 322 can fit tightly into the headrest support slide 323 without movement in any direction once positioned, set and tightened. The occipital head set point 322 may be easily adjustable for height to fit specifically to the subject.

The frontal support slide 324 to support the frontal head set point 321 is attached to the headrest support slide 323. The frontal head set point 321 may include one or more touch points. The frontal support slide 324 can be adjustably attached to the headrest support slide 323 and/or be vertically adjustable within the headrest support slide 323. The frontal support slide 324 may include a two track support with a lock for reticulated rule positioning. For example, the frontal support slide 324 may include a vertical reticulation rule for the frontal head set point 321. The frontal support slide 324 should not warp and may comprise a frame made from extruded aluminum.

The frontal head set point 321 is attached to the frontal support slide 324. The touch points of the frontal head set point 321 may have rounded ends to serve as touch points to the back of the frontal bone of the head. The rounded ends can prevent indentation and discomfort to the subject. The touch points may be of any hard washable material such as molded plastic such as nylon, polycarbonate, polyethylene or polystyrene or the like, and be of sufficient strength so as to not warp with head pressure. The touch points may be positioned so that the touch points do not contact the parietal bone. The frontal head set point 321 can fit tightly into the headrest support slide 323 without movement in any direction once positioned, set and tightened. The frontal head set point 321 may be easily adjustable for head shape to fit specifically to the subject.

In some embodiments, the occipital head set point 322 only includes two touch points that touch the occipital bone of the skull, such that, when in combination with a single touch point of the frontal head set point 321 touches the frontal bone of the skull, only three touch points are in contact with the skull. The three point touch system prevents movement by the subject. A two point touch may not prevent rotation, yaw and tilt, and a four point touch (or great number of touch points) may result in crimping of the head and discomfort to the subject.

The headrest 320 can also include neck alignment member 341. The neck alignment member 341 can be positioned to touch the back of the subject's neck. The neck alignment member 341 may or may not provide any support. Instead, the neck alignment member 341 can provide a measurement of the position of the subject's neck so that the subject's neck can be realigned.

The chair-headrest device 300 may further include a main support bracket that holds the adjustable support stand 330 and connects directly to the chair 310 at a seat attachment level. The main support bracket may be integral with the chair 310 and with a main support column of the adjustable support stand 330. The main support bracket should not warp with attachment of the headrest 320 or secondary support brackets. Furthermore, the main support bracket may include a stabilizer to prevent vibration and to maintain level due to subject weight.

Other types of devices other than the chair-headrest device 300 can be used with parallax devices 100, 200, 400. For example, although in certain applications described herein desire that the face, neck, chin, and/or forehead not be restrained such that the skin of the face, neck, chin, and/or forehead is not modified and the subject is not deformed, other applications may not have such requirements and may still benefit from included use of the parallax devices 100, 200, 400.

For example, there are several subject chairs available for imaging. These include a standard chair, a padded chair, an adjustable office chair with multiple axes of adjustment. Furthermore, chair assemblies may be intended for restraining a subject for the specific purposes of imaging. These chair assemblies include head (e.g., chin, ear, mouth) restraints either integrally, or in combination, some also include a partial circle rail or assembly for holding the image acquisition cameras or instruments. These chair assemblies may or may not include a foot rest, may or may not rotate, may or may not elevate. The head restraint may be adjustable and comprised of an ear restraint, a mouth restraint, helmet, forehead restraint, chin restraint, etc.

In addition, a jaw restraint can be used in addition to the chair-headrest device 300. For example, the jaw restraint can include a fitted mouth-guard or a mouth freshening tab held between the subject's teeth. The jaw restraint can be sized so that the jaw restraint does not substantially alter the subject's facial features.

The devices disclosed herein may be used with any fixed location image acquisition device, single frame, dynamic frame, 3D, or multiple head image acquisition system and is a relatively inexpensive subject repositioning system.

Since the device and the additional aspects of the chair with back of head and top of head touch points does not encumber the head, face and neck, imaging may be conducted and images acquired with a wide variety of cameras and using a variety of lighting options including light type, intensity and direction. In this manner, the device and system permits alternate lighting direction and sources to be employed while having the subject return to the same location.

The systems and devices described above allow for alignment of a face in a specific direction eliminating rotation, yaw, and tilt (e.g., maintaining head tilt, yaw, and rotation position). The fine adjustment aspect of the device may also be obtained in tandem with a positioning chair with headrest. The head is touched at two points behind the head and on the top of the head such that the touch points do not influence the face or neck (e.g., not within imaging areas). The three touch points allow the subject to remain in a set position.

By the subject setting their head in the chair alignment device, a starting location can be defined. The head is adjusted further with very small movements of both the head and the parallax bar assemblies to attain a position which is both defined and repeatable based on recording and resetting the chair parameters and parallax bar assemblies to the recorded and then preset values. By these means, the subject may be realigned without any device impinging on the forehead, face, or neck.

The parallax wires eliminate up-down and forward-backward tilt of the head and assures the position is repeatable by alignment of subject's eyes with the first and second parallax wires (e.g., front wire fully aligns with back wire). The left-right rotation of the head is eliminated and the position assured by the centered orientation of the fourth parallax wire between the binocularly doubled (as a result of human binocular vision) third parallax wire. The yaw (head tilt to left, head tilt to right) is eliminated automatically by use of both the first and second parallax wires and the third and fourth parallax wires.

As such, a method of aligning a device with respect to a subject may include positioning, to a first position, a first parallax bar assembly comprising a first wire and a second wire spaced a first distance from and substantially parallel to the first wire such that a line of sight of the subject intersects the first and second wires. For example, the method may include at least partially occluding the second wire from the subject.

The method may further include positioning, to a second position, a second parallax bar assembly comprising a third wire and a fourth wire spaced a second distance from and parallel to the third wire such that the line of sight of the subject generally intersects the third and fourth wires. For example, the second parallax bar assembly may be positioned such that the fourth wire is equal distance from each of subject's observed images of the third wire. The positioning of the second parallax bar assembly may further include positioning a common plane that the third and fourth wires lie substantially equal distance between eyes of the subject.

The method may include moving the first parallax bar assembly from the first position and moving the second parallax bar assembly from the second position, and repositioning the first parallax bar assembly to the first position after moving the first parallax bar assembly and repositioning the second parallax bar assembly to the second position after moving the second parallax bar assembly.

Methods may also include having the subject sit erect in the positioning chair and placing their head against the back head rest (top of occipital bone). The subject may be positioned or repositioned and the position recorded. The subject looks forward toward the parallax wires. Parallax wires are spatially fixed in location and alignment with the positioning chair. The parallax wires are slowly raised or lowered to meet the horizontal gaze of the subject.

The subject can maintain a sitting position with their head against back headrest, and the subject can rotate, yaw, and/or tilt their head so that the closer first parallax wire completely and evenly occludes the farther second parallax wire as seen by both eyes. A lighter color closer wire and a darker color farther wire improve this alignment. The parallax wires are fixed in height and the height is recorded.

While the subject maintains this head position and maintains the first and second parallax wire overlay, the subject slightly turns head left or right to center the farther fourth parallax wire between the binocular images of the closer third parallax wire. When the third and fourth parallax wire position is found, and the first and second parallax wire position is maintained, the top of head touch point bracket is adjusted into place (top of frontal bone) and fixed, and the position recorded.

Images are obtained with the subject maintaining the fixed touch points on the head. At this point the subject may use open or closed eyes. So long as the touch points are maintained, the head can be properly positioned.

If the subject leaves the imaging position (chronology, break, etc.), upon returning, the subject sits in the chair as positioned and places head in the headrest assembly (with predefined recorded positions) and adjusts their gaze to realign with the preset location of the parallax bars/wires. The head is now relocated (chair and headrest assembly), and the specific gaze direction and fine relocation is reset (parallax bars/wires).

The parallax wires may be used independently of the chair and headrest assembly for the purposes of fixing the gaze of a subject in a specific position. The parallax bar assemblies are adjustable by the support stand so the vertical height may be adjusted. As such, the parallax wires may be used to fix a subject's gaze in almost any direction whether standing or sitting.

While the systems and devices were described for the purpose of maintaining subject position and reposition for 3D imaging for cosmetic analysis, the systems and devices described herein are generally applicable for any imaging purpose (2D or 3D) where the subject needs to be positioned and repositioned in a uniform and repeatable manner.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein. Furthermore, the advantages described above are not necessarily the only advantages of the invention, and it is not necessarily expected that all of the described advantages will be achieved with every embodiment of the invention.

What is claimed is:

1. A system for positioning a subject comprising:
a first parallax bar assembly comprising a first wire and a second wire spaced a first distance and parallel to the first wire;
a second parallax bar assembly comprising a third wire and a fourth wire spaced a second distance and parallel to the third wire;
wherein the first and second wires are substantially perpendicular to the third and fourth wires, and an imaginary straight line intersects the first, second, third, and fourth wires.

2. The system of claim 1, wherein the first parallax bar assembly further comprises a first support parallax bar having a first portion and a second portion, the first and second wires extending from the first portion to the second portion of the first support parallax bar.

3. The system of claim 1, wherein the second parallax bar assembly further comprises a second support parallax bar having a first portion and a second portion, the third and fourth wire extending from the first portion to the second portion of the second support parallax bar.

4. The system of claim 1, further comprises an adjustable support stand configured to provide vertical adjustment of the first, second, third, and fourth wires.

5. The system of claim 4, further comprises an adjustable support bracket configured to provide horizontal adjustment of the first, second, third, and fourth wires.

6. The system of claim 1, further comprising a back target positioned along the imaginary straight line and having a back target color that is different from a color of at least one of the first, second, third, and fourth wires.

7. The system of claim 1, wherein first, second, third, and fourth wires are adjustable in a first direction.

8. The system of claim 7, wherein first, second, third, and fourth wires are adjustable in a second direction substantially orthogonal to the first direction.

9. The system of claim 1, wherein the first and second wires lie in a first plane and the third and fourth wires lie in a second plane that is orthogonal to the first plane.

10. The system of claim 1, wherein the first and second wires are configured to be generally tangential to a ground plane in use, and the third and fourth wires are configured to be generally perpendicular to the ground plane in use.

11. The system of claim 1, wherein the first distance is between about 2 and about 12 inches, and the second distance is between about 0.5 and about 12 inches.

12. The system of claim 1, wherein the first wire has a first thickness and the second wire has a second thickness greater than the first thickness.

13. The system of claim 1, wherein the first wire has a first color and the second wire has a second color different from the first color.

14. The system of claim 1, further comprising an alignment chair with a headrest configured to restrict movement of a subject's head without touching a subject's face, neck, chin or forehead.

15. The system of claim 14, wherein the headrest comprises at least two occipital touch points configured to touch an occipital portion of a subject's head where a first occipital touch point is generally on a right side of the subject's head and a second occipital touch point is generally on a left side of the subject's head, and at least one frontal touch point configured to touch a frontal portion of the subject's head.

16. The system of claim 14, further comprising a template, wherein the alignment chair is configured to be rotatable about an axis perpendicular to a plane of template and removably engaged with the template at at least two positions on the template.

17. The system of claim 16, wherein the template is configured so that the alignment chair is horizontally movable relative to the parallax device.

18. A method of aligning a device with respect to a subject, the method comprising:
positioning, to a first position, a first parallax bar assembly comprising a first wire, and a second wire spaced and parallel to the first wire such that a line of sight of the subject intersects the first and second wires; and
positioning, to a second position, a second parallax bar assembly comprising a third wire and a fourth wire spaced and parallel to the third wire such that the line of sight of the subject generally intersects the third and fourth wires.

19. The method of claim 16 further comprising:
moving the first parallax bar assembly from the first position, and moving the second parallax bar assembly from the second position;
repositioning the first parallax bar assembly to the first position after moving the first parallax bar assembly, and repositioning the second parallax bar assembly to the second position after moving the second parallax bar assembly.

20. The method of claim 18, further comprising at least partially occluding the second wire from the subject.

21. The method of claim 18, wherein the positioning of the second parallax bar further comprises positioning the second parallax bar assembly such that the fourth wire is equal distance from each of subject's observed images of the third wire.

22. A device for positioning a subject comprising:
a chair;
a headrest system adjustable relative to the chair, the headrest system comprising:
an occipital head set point having at least one occipital touch point configured to touch an occipital portion of a head of a subject; and
a frontal head set point having at least one frontal head touch point configured to touch a frontal portion of the head of the subject,
wherein the occipital head set point and frontal head set point are adjustable in at least two dimensions.

23. The device of claim 22, wherein the occipital head set point comprises at least two occipital touch points separated by a distance and configured to both touch the occipital portion of the head with at least one occipital touch point on each side of a sagittal plane of the subject

24. The device of claim 22, further comprising an adjustable support stand that mechanically couples the headrest system to the chair and adjustably moves the headrest system in the at least two dimensions.
